(19) United States
(12) Patent Application Publication
(10) Pub. No.: US 2026/0087522 A1
(43) Pub. Date: Mar. 26, 2026

(54) DYNAMIC DIGITAL SIGNAGE BASED ON REAL-TIME MOVEMENT

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/891,448

(22) Filed: Sep. 20, 2024

(51) Int. Cl. G06Q 30/0251; H04W 4/029

(52) U.S. Cl. CPC G06Q 30/0269; H04W 4/029

(57) ABSTRACT

A method includes receiving, via a phased array antenna, signals from one or more wireless devices, determining a location and a movement of each of the one or more wireless devices, and selecting an advertisement from a database of advertisements for display by a digital signage device based on whether the one or more wireless devices are in a first group that is localized within a particular radius, whether the one or more wireless devices are in a second group that is not localized within the particular radius, and, if at least one of the one or more wireless devices is not in the first group or the second group, whether the at least one of the one or more wireless devices is moving faster than a threshold velocity relative to the digital signage device.

### FIELD OF THE DISCLOSURE

The present disclosure is related generally to device tracking and more specifically to dynamic user-tracking digital signage systems and methods.

### BACKGROUND

Current digital signage systems often display generic advertisements, failing to engage audiences by not tailoring content to individual users'interests or demographics. Many existing systems do not have the capability to accurately track and analyze the movements and behaviors of individuals near the signage, resulting in missed opportunities for targeted content delivery. Digital signage systems frequently display static or pre-scheduled content, which may not be relevant to the current audience, leading to inefficient use of advertising space and reduced effectiveness of campaigns. Current systems struggle to adapt quickly to changes in audience composition, such as different group sizes or diverse interests, limiting the ability to present relevant ads in real time. Some digital signage solutions lack analytics capabilities to provide detailed insights into audience engagement, behavior patterns, and the effectiveness of displayed content, making it difficult to optimize advertising strategies. Existing digital signage systems often lack the ability to understand and respond to the context of their environment, such as the time of day, current events, or nearby activities, which could enhance the relevance and appeal of displayed content. Thus, there is a need in the prior art for a dynamic user-tracking digital signage system.

### SUMMARY

The present disclosure includes a system and method for dynamic user-tracking digital signage that solves the problems of conventional approaches. According to one aspect, a system includes a digital signage device configured to display an advertisement selected from a plurality of advertisements in a database. The system also includes a phased array antenna and a signal processing module configured to receive, via the phased array antenna, signals from one or more wireless devices and determine a location and a movement of each of the one or more wireless devices. The system further includes at least one processor configured to select the advertisement for display by the digital signage device based on whether the one or more wireless devices are in a first group that is localized within a particular radius, whether the one or more wireless devices are in a second group that is not localized within the particular radius, and if at least one of the one or more wireless devices is not in the first group or the second group, whether the at least one of the one or more wireless devices is moving faster than a threshold velocity relative to the digital signage device.

In some embodiments, the one or more wireless devices are respectively associated with one or more profiles of characteristics and/or preferences, and wherein the at least one processor is configured to, if the one or more wireless devices are within the first group, analyze the one or more profiles of the one or more wireless devices for shared characteristics and/or preferences specific to the first group and filter the database for an advertisement specific to the shared characteristics and/or preferences of the first group.

In some embodiments, the one or more wireless devices are respectively associated with one or more profiles of characteristics, preferences, and/or demographic information, and wherein the at least one processor is configured to, if the one or more wireless devices are within the first group, analyze the one or more profiles of the one or more wireless devices for common characteristics, preferences, and/or demographics and filter the database for the advertisement that is suitable for a diverse audience or is specific to the common characteristics, preferences, and/or demographics of the second group.

In some embodiments, the at least one of the one or more wireless devices that is not in the first group or the second group is associated with a profile associated with characteristics and/or preferences, and the at least one processor is configured to, if the at least one of the one or more wireless devices is moving faster than the threshold velocity relative to the digital signage device, filter the database for a first type of advertisement based on the profile, and, if the at least one of the one or more wireless devices is not moving faster than the threshold velocity relative to the digital signage device, filter the database for a second type of advertisement based on the profile.

In some embodiments, the first type of advertisement is pre-classified based on its suitability for rapid consumption, and the second type of advertisement is pre-classified as including detailed content not suitable for rapid consumption.

In some embodiments, the at least one of the one or more wireless devices is a cell phone and/or an asset tag. The asset tag may include one or more of a radio frequency identification (RFID) tag, a near field communication (NFC) tag, a Wi-Fi tag, a global position system (GPS) tag, and/or a long range (LoRa) tag.

In some embodiments, the signal processing module is configured to determine the location of each of the one or more wireless devices using at least one of an Angle of Arrival (AoA) measurement, a Kalman filter, a Joint Probabilistic Data Association (JPDA) operation, and/or a Multiple Signal Classification (MUSIC) algorithm.

In some embodiments, the signal processing module is configured to determine the location of each of the one or more wireless devices by triangulation and/or trilateration.

In some embodiments, the signal processing module operates in an active mode by initially pinging the one or more wireless devices via the phased array antenna before detecting the signals. Alternatively, or in addition, the signal processing module operates in a passive mode by detecting the signals without first pinging the one or more wireless devices.

According to another aspect, a method includes receiving, via a phased array antenna, signals from one or more wireless devices. The method also includes determining a location and a movement of each of the one or more wireless devices. The method further includes selecting an advertisement from a database of advertisements for display by a digital signage device based on whether the one or more wireless devices are in a first group that is localized within a particular radius, whether the one or more wireless devices are in a second group that is not localized within the particular radius, and, if at least one of the one or more wireless devices is not in the first group or the second group, whether the at least one of the one or more wireless devices is moving faster than a threshold velocity relative to the digital signage device.

In some embodiments, the one or more wireless devices are respectively associated with one or more profiles of characteristics and/or preferences, and wherein selecting includes, if the one or more wireless devices are within the first group, analyzing the one or more profiles of the one or more wireless devices for shared characteristics and/or preferences specific to the first group and filtering the database for an advertisement specific to the shared characteristics and/or preferences of the first group.

In some embodiments, the one or more wireless devices are respectively associated with one or more profiles of characteristics, preferences, and/or demographic information, and wherein selecting includes, if the one or more wireless devices are within the first group, analyzing the one or more profiles of the one or more wireless devices for common characteristics, preferences, and/or demographics and filtering the database for the advertisement that is suitable for a diverse audience or is specific to the common characteristics, preferences, and/or demographics of the second group.

In some embodiments, the at least one of the one or more wireless devices that is not in the first group or the second group is associated with a profile associated with characteristics and/or preferences, and wherein selecting includes, if the at least one of the one or more wireless devices is moving faster than the threshold velocity relative to the digital signage device, filtering the database for a first type of advertisement based on the profile, and, if the at least one of the one or more wireless devices is not moving faster than the threshold velocity relative to the digital signage device, filtering the database for a second type of advertisement based on the profile.

In some embodiments, the first type of advertisement is pre-classified based on its suitability for rapid consumption, and the second type of advertisement is pre-classified as including detailed content not suitable for rapid consumption.

In some embodiments, the at least one of the one or more wireless devices is a cell phone and/or an asset tag. The asset tag may include one or more of a radio frequency identification (RFID) tag, a near field communication (NFC) tag, a Wi-Fi tag, a global position system (GPS) tag, and/or a long range (LoRa) tag.

In some embodiments, determining the location of each of the one or more wireless devices includes using at least one of an Angle of Arrival (AoA) measurement, a Kalman filter, a Joint Probabilistic Data Association (JPDA) operation, and/or a Multiple Signal Classification (MUSIC) algorithm.

In some embodiments, determining the location of each of the one or more wireless devices includes determining the location of each of the one or more wireless devices by triangulation and/or trilateration.

In some embodiments, receiving includes actively pinging the one or more wireless devices via the phased array antenna before detecting the signals, or passively detecting the signals without first pinging the one or more wireless devices.

### BRIEF DESCRIPTION OF THE DRAWINGS

FIG. 1 is a schematic diagram of a dynamic user-tracking digital signage system.

FIG. 2 is a flow chart of a method performed by a Signal Processing Module.

FIG. 3 is a flow chart of a method performed by a Communication Module.

FIG. 4 is a flow chart of a method performed by a Base Module.

FIG. 5 is a flow chart of a method performed by a Quick Ad Module.

FIG. 6 is a flow chart of a method performed by a Detailed Ad Module.

FIG. 7 is a flow chart of a method performed by a Group Ad Module.

FIG. 8 is a flow chart of a method performed by a Scattered Ad Module.

FIG. 9 is a flow chart of a method performed by a Display Module.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

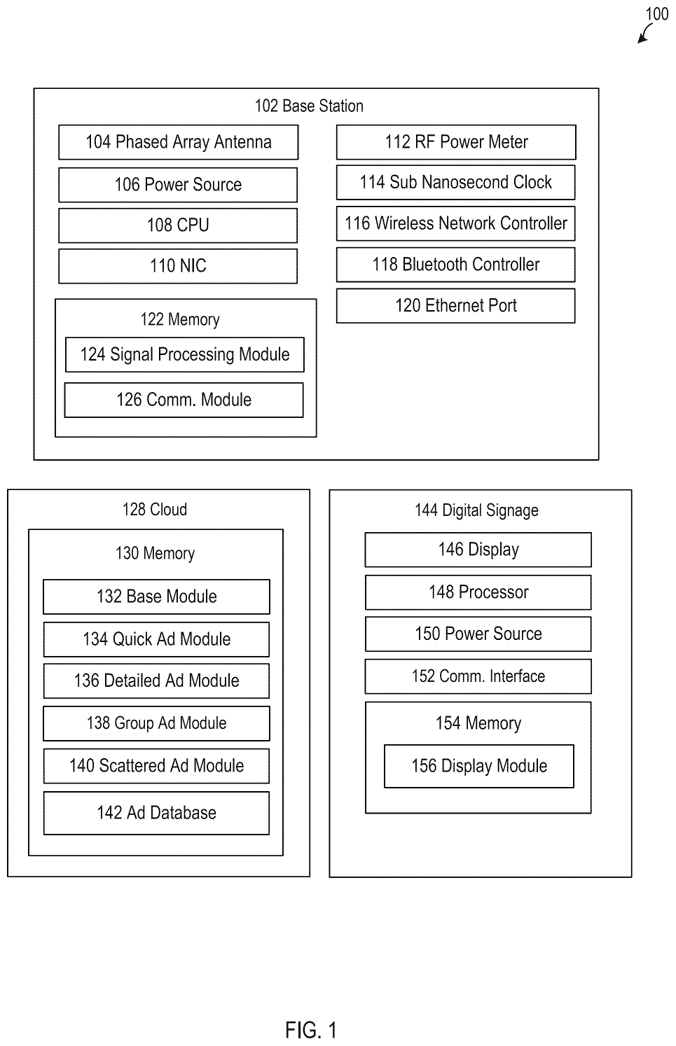

FIG. 1 illustrates a dynamic user-tracking digital signage system 100 (or “system 100”). The system 100 includes a base station 102 that may be designed to capture, process, and transmit data related to user devices in the vicinity. The base station 102 may be equipped with hardware, including a phased array antenna 104, to detect signals from wireless devices such as smartphones or asset tags, such as, without limitation, radio frequency identification (RFID) tags, near field communication (NFC) tags, Wi-Fi tags, global position system (GPS) tags, and/or long range (LoRa) tags. The phased array antenna 104 may be capable of dynamic beamforming, allowing the base station 102 to focus on specific directions and enhance the accuracy of signal detection. The base station's 102 may determine the position and movement of the devices through a series of software modules, including the Angle of Arrival, or AoA, module, the Kalman module, the track module, and the Joint Probabilistic Data Association, or JPDA, module. In some embodiments, the AoA module calculates the precise direction of incoming signals by analyzing the time and phase differences in the signals captured by different elements of the antenna array. In some embodiments, the Kalman module may further refine the data by predicting device positions and movements with high accuracy by filtering and smoothing the signal data. In some embodiments, the track module may manage the identification and continuous monitoring of multiple devices to ensure that each signal is correctly matched to its respective device. In some embodiments, the JPDA module may enhance the process by optimizing the data association, particularly in environments with multiple devices, ensuring reliable and accurate tracking. In some embodiments, the base station 102 may transmit the collected data to the cloud 128, including detailed information on the position and movement of detected devices, which the cloud 128 may then use to determine the appropriate advertisements to display.

In some embodiments, the base station 102 may utilize Synthetic Aperture Radar, or SAR, and other 3D mapping techniques to enhance its tracking and analytical capabilities. In some embodiments, the SAR may create high-resolution images of objects and landscapes by emitting microwave signals toward a target area and measuring the reflected signals to produce detailed images. In some embodiments, SAR may achieve high resolution by moving the radar antenna along a path and combining the signals from multiple positions, simulating a much larger antenna. For example, a SAR system mounted on the base station 102 may continuously scan the area, emitting microwave signals and capturing the reflected signals from objects and people. In some embodiments, the system 100 may process the signals to construct a detailed 3D map of the surroundings, including the position, orientation, and movement of individuals. In some embodiments, the 3D mapping techniques may include, but are not limited to, LiDAR or light detection and ranging, stereo vision, Time-of-Flight cameras, structured light scanning, etc. In some embodiments, the data collected by the base station may determine the direction people are facing, how long people are idling in a specific area, etc., by using the tracking data from the base station 102 as well as the 3D data.

In some embodiments, the base station 102 may include an integrated camera, which may be a high-resolution, multifunctional device designed to enhance the system's capabilities through imaging and analysis. In some embodiments, the camera may capture real-time video feeds or images with high-definition clarity to ensure that detailed visual data of the surrounding area and individuals within its field of view are accurately recorded. In some embodiments, the camera may be equipped with a wide-angle lens to cover a broad area. In some embodiments, the camera may perform face detection and recognition by using computer vision algorithms to identify human faces within the video frames, distinguishing them from other objects and backgrounds, and providing the ability to personalize the content displayed on the digital signage 144. In some embodiments, the camera may be equipped with sentiment analysis software to interpret facial expressions to determine the emotional states of individuals. In some embodiments, the sentiment analysis software may analyze subtle changes in facial muscles and expressions to gauge whether a person is happy, surprised, confused, or indifferent. For example, suppose a person appears interested and happy. In that case, the system 100 might display more related advertisements or offers, or if a person looks confused, the system 100 can provide helpful information or directions. In some embodiments, the camera may perform demographic analysis to identify characteristics such as age, gender, and group size to better understand the audience composition and preferences, allowing for more targeted advertising strategies.

Further, embodiments may include a phased array antenna 104, which includes an array of elements that may function in both passive and active modes. In the passive mode, the antenna 104 does not transmit any signals but listens to all wireless traffic within its vicinity, capturing signals without interacting with the devices being monitored. In some embodiments, the passive approach allows for discreet monitoring and reduces the likelihood of detection by the tracked devices. In the active mode, the antenna 104 may transmit signals (e.g., pinging the wireless devices) and then receive the reflected signals back, enabling more dynamic interaction with the environment. The phased array antenna 104 may be designed to operate at 2.4 GHz, with each antenna element being 2.1 inches in size, forming a 16-channel array that measures approximately 20 inches by 20 inches. In some embodiments, the configuration allows the antenna 104 to cover a wide area and detect signals from multiple devices simultaneously. The array's design supports both angle of arrival, or AoA, measurements and Doppler shift calculations, which may be used to determine the direction and movement of the tracked devices. The antenna 104 may also include null space reduction, which helps identify and minimize the effects of nulls or dead zones in the signal reception pattern. The null space reduction may analyze the signals received from different antennas in the array and adjust the reception parameters to improve signal clarity and reduce interference. In some embodiments, the phased array antenna 104 may support signal processing capabilities. The phased array antenna 104 may work in conjunction with tools such as the Kalman filter for prediction and smoothing of device positions, the Joint Probabilistic Data Association, or JPDA, for accurate data association in environments with multiple devices, and an outlier module to eliminate false signals and improve overall tracking accuracy. These features collectively enable the system 100 to provide precise and reliable tracking and interaction with wireless devices in its vicinity.

Further, embodiments may include a power source 106, which may be an AC power supply, providing a stable and continuous source of electricity. In some embodiments, the AC power supply ensures that the base station 102 operates without interruption, supporting the continuous monitoring and reporting of wireless device activities within the coverage area. In some embodiments, the base station 102 may rely on DC power sources, such as batteries or rechargeable battery packs. These portable power sources 106 enable the base station 102 to be used in dynamic or remote environments where access to AC power is limited or unavailable. In some embodiments, rechargeable batteries may provide the flexibility of being recharged and reused, making them suitable for operations that require mobility or temporary setups, such as event monitoring, security patrols, or search and rescue missions.

Further, embodiments may include a CPU 108, or central processing unit, which may be the component responsible for executing instructions and managing the operations of the system 100. The CPU 108 may be a highly integrated electronic circuit that performs arithmetic, logic, control, and input/output operations specified by the instructions in the program. In some embodiments, the CPU 108 in the base station 102 may be designed to handle the demanding processing requirements associated with the various technologies integrated into the system 100. In some embodiments, the CPU 108 may be a multi-core processor featuring multiple processing units or cores on a single chip. Each core is capable of executing its instructions independently of the others, allowing for parallel processing.

Further, embodiments may include a network interface card, or NIC 110, which may be a hardware component that enables the base station 102 to connect to a network. The NIC 110 may be designed to handle all the functions for establishing and maintaining network communication. In some embodiments, the NIC 110 may include several components, such as the network interface controller, transceivers, and connectors, housed on a single board. The NIC 110 may operate by interfacing with the base station's 102 operating system and network software to manage data transmission and reception over a network. In some embodiments, the NIC 110 may provide a physical interface for the network cable, such as Ethernet, Wi-Fi, or other types of network connections. In some embodiments, the NIC 110 may contain transceivers that convert electrical signals to and from network cables into data the base station 102 can process. In some embodiments, the NIC 110 may include connectors and other circuitry to manage the electrical signals and ensure efficient and accurate data transmission. The NIC 110 may prepare data for transmission over the network and to process incoming data. The NIC 110 may encapsulate data packets according to the network protocols being used, manage error detection and correction, and control the flow of data to prevent congestion. The NIC 110 may handle the conversion of data from parallel to serial form for transmission over the network medium and from serial to parallel form upon receipt. In some embodiments, the NIC 110 may include firmware or software that interfaces with the base station's 102 operating system. The software component may be responsible for handling the low-level operations of network communication, such as packet generation, data buffering, and signal encoding/decoding. The NIC 110 firmware may ensure that the hardware functions are abstracted in a way that the operating system can manage network communication seamlessly, allowing for network drivers to facilitate communication between the base station 102 and the network.

In some embodiments, the NIC 110 may include a network interface controller, which may be a chip or a set of integrated circuits that handles the processing of network data and communication tasks. The network interface controller may be responsible for the actual management of data transfer between the computer's internal bus system and the network media. In some embodiments, the network interface controller may manage the sending and receiving of data packets, ensuring that data is transmitted correctly and efficiently across the network. When data is sent from the base station 102, the controller takes parallel data from the base station's 102 bus and converts it into serial data to be sent over the network cable. Conversely, when data is received, the controller converts serial data from the network back into parallel data for the base station 102 to process. In some embodiments, the controller may handle error detection and correction by using various algorithms to check the integrity of the data packets being transmitted and received to ensure that errors are detected and corrected before the data reaches its destination. In some embodiments, the controller may manage the data buffering process by temporarily storing data in buffers to smooth out the differences in data transmission rates between the base station 102 and the network to help manage network congestion and ensure that data flows smoothly without overwhelming either the sending or receiving ends. In some embodiments, the controller may manage network protocols by handling the low-level operations used by different network protocols, such as Ethernet or Wi-Fi, including addressing, packet framing, and collision detection and avoidance, allowing the NIC 110 to communicate effectively over various types of networks and ensures compatibility with different networking standards.

Further, embodiments may include an RF power meter 112, which may measure and monitor the power levels of radio frequency signals transmitted and received by the phased array antenna 104. The RF power meter 112 includes a high-precision sensor capable of detecting RF power across a wide range of frequencies, an analog-to-digital converter, or ADC, for accurate signal processing, and a microcontroller unit, or MCU, to manage data collection and analysis. The sensor continuously measures the RF power of signals, converting these measurements into electrical signals that the ADC digitizes. The digitized data is then processed by the MCU, which interprets the power levels and provides real-time feedback to the system 100. In some embodiments, the RF power meter 112 ensures that the antenna 104 operates within optimal power levels, avoiding underpowered or overpowered conditions that could degrade performance. The power meter 112 may dynamically adjust the transmission power to maintain consistent signal strength and quality, compensating for environmental changes or variations in signal propagation to maintain efficient communication links and prevent signal loss or distortion.

Further, embodiments may include a sub-nanosecond clock 114, which may be a timing device designed to provide highly accurate and precise synchronization for the operations of the phased array antenna 104. The sub-nanosecond clock 114 may generate timing signals with a resolution of less than one nanosecond for applications requiring ultra-high precision in signal processing and communication. In some embodiments, the sub-nanosecond clock 114 includes an oscillator, such as a crystal oscillator or an atomic clock, to facilitate minimal drift and high accuracy over time. The oscillator may be connected to a phase-locked loop, or PLL, a circuit that multiplies the base frequency to achieve the desired sub-nanosecond resolution. In some embodiments, the PLL may ensure that the timing signals remain stable and synchronized with the system's operations. In some embodiments, the sub-nanosecond clock 114 may ensure that the transmission and reception of signals are accurately synchronized to maintain the integrity of the communication link and avoid timing errors that could lead to data corruption or loss. In some embodiments, the sub-nanosecond clock 114 provides precise timestamps for the received signals to allow the base station 102 to accurately calculate the time differences between signals arriving at different elements of the phased array to determine the exact direction of the incoming signals. In some embodiments, the sub-nanosecond clock 114 may enable the base station 102 to measure minute changes in the frequency of the received signals due to the Doppler effect, allowing for accurate tracking of the speed and direction of the devices. In some embodiments, the sub-nanosecond clock 114 may provide the timing reference for the digital signal processor, or DSP, and other processing units within the base station 102 to ensure that all data processing tasks are performed in a synchronized manner.

Further, embodiments may include a wireless network controller 116, which may be responsible for managing wireless communications between the base station 102 and the wireless devices within their vicinity. In some embodiments, the wireless network controller 116 may oversee the operations of the NIC 110, including signal monitoring, data capture, and communication with other system components. The wireless network controller 116 may operate by placing the NIC 110 into a specific mode, such as monitor mode, which allows the NIC 110 to passively listen to all wireless traffic within its range without initiating any connections or interactions with the devices being monitored. The wireless network controller 116 may capture various wireless frames, particularly management frames such as probe requests. These frames contain various information, such as MAC addresses, SSIDs, signal strengths, and supported rates of the wireless devices. By capturing and processing these frames, the wireless network controller helps build a comprehensive profile of each detected device. In some embodiments, the wireless network controller 116 may periodically scan different frequency channels. This scanning process allows the NIC 110 to detect devices operating on various channels, minimizing the chances of missing any signals. Additionally, the wireless network controller 116 may engage in channel hopping, in which the NIC 110 frequently switches between channels at specified intervals, further enhancing the detection capability by broadening the range of monitored frequencies. The wireless network controller 116 may perform data extraction to isolate relevant information from the frames, which may involve focusing on details such as MAC addresses, network names (SSIDs), and signal strengths. The extracted data is then preprocessed to filter out irrelevant or redundant information, ensuring that valuable and pertinent data is retained. The refined data may be structured in a format that facilitates efficient transmission to the system's servers for further processing and analysis. In some embodiments, the wireless network controller 116 may ensure that the data is serialized and encrypted, maintaining the integrity and security of the information during transmission.

Further, embodiments may include a Bluetooth controller 118, which may be responsible for managing Bluetooth communications between the base station 102 and Bluetooth-enabled devices. The Bluetooth controller 118 may control the Bluetooth chipset, enabling the detection, tracking, and processing of Bluetooth signals within the base station's 102 vicinity. In some embodiments, the Bluetooth controller 118 may operate by placing the Bluetooth chipset into a passive monitoring mode. In this mode, the chipset listens to Bluetooth signals within its range without actively connecting or interacting with the devices being monitored. The Bluetooth controller 118 may capture various Bluetooth packets, including device names, Bluetooth addresses, signal strengths, supported services, and other metadata. By capturing and processing these packets, the Bluetooth controller 118 builds a comprehensive profile of each detected Bluetooth-enabled device. In some embodiments, the Bluetooth controller 118 may perform data extraction to isolate relevant information from the packets, which may involve focusing on details such as Bluetooth addresses, device names, and signal strengths, which form the basis for further analysis and processing. The extracted data is then preprocessed to filter out irrelevant or redundant information, ensuring that valuable and pertinent data is retained. The refined data is structured in a format that facilitates efficient transmission to the system's servers for further processing and analysis. The Bluetooth controller 118 ensures that the data is serialized and encrypted, maintaining the integrity and security of the information during transmission.

Further, embodiments may include an ethernet port 120, which may be a hardware interface that enables wired network connectivity for the base station 102 and other system components. The ethernet port 120 may facilitate the transmission and reception of data between the base station 102 and the system's servers or other networked devices over a wired Ethernet connection. In some embodiments, the ethernet port 120 may enable the base station 102 to transmit captured and processed data to the system's servers for further analysis and storage. This data may include wireless signal information, device metadata, and other relevant tracking and authentication details.

Further, embodiments may include a memory 122, which may be implemented as flash memory, which contains code logic for various functions, including monitoring, reporting, and other processing tasks. The memory 122 may contain software, such as the signal processing module 124 and the communication module 126. The memory 122 may be responsible for temporarily storing the captured wireless signals and their metadata, ensuring that the data is readily accessible for preprocessing and transmission to the system's servers. In some embodiments, the memory 122 may store configuration settings, firmware updates, and other files that enable the base station 102 to function efficiently and effectively.

Further, embodiments may include a signal processing module 124, which may be responsible for receiving and processing signals from nearby wireless devices. The signal processing module 124 begins by capturing the signal transmitted by target devices using a phased array antenna. The signal processing module 124 then executes the AoA module, which determines the direction from which a wireless signal originates by analyzing time and phase differences in the signals received by different elements of the antenna array. The signal processing module 124 executes the Kalman module, which uses the Kalman Filter technique to predict the position and movement of the devices by filtering and smoothing the incoming signal data, providing accurate real-time tracking. The signal processing module 124 executes the track module, which ensures continuous and accurate tracking by matching incoming signals to their respective devices and manages the initiation, maintenance, and termination of tracking for multiple devices. The signal processing module 124 executes the JPDA module, which handles data association in environments with multiple devices, optimizing the assignment of signals to devices and ensuring accurate tracking. The signal processing module 124 executes the outlier module, which manages out-of-sequence measurements, ensuring that tracking accuracy is maintained even when data packets are received in an unexpected order. The signal processing module 124 executes the generation module, which converts raw sensor data into a standardized, usable format for further processing, ensuring that the data is accurate and ready for transmission to the cloud 128. The signal processing module 124 then sends the data to the communication module 126 to be transmitted to the cloud 128.

In addition, or alternatively, the signal processing module 124 may use received signal strength to perform trilateration. Trilateration is an alternative method of determining the position of a signal source by calculating the distances between the source and multiple receiving antennas. Distance estimation can be performed using Angle of Arrival (AoA) data, where known positions of the antennas and the angles of the incoming signal are used to infer the distance. However, a more direct and sometimes more precise method may involve deriving the distance from the difference in signal strength received at two or more antennas. The principle behind this method is based on the inverse relationship between signal strength and distance. As the distance from the signal source to the antenna increases, the signal strength decreases, typically following an inverse-square law or a similar attenuation model depending on the environment. In scenarios where trilateration is implemented, the base station 102 may use at least three antennas to determine the exact location of the signal source. The use of three antennas allows the formation of three independent distance equations, which, when solved simultaneously, may provide a unique intersection point corresponding to the location of the signal source. The received signal strength at each antenna may provide the basis for calculating the respective distances. For example, if the signal at one antenna is stronger by a known percentage compared to another, the ratio of these signal strengths can be used to infer the ratio of the distances. By combining this information with the known physical separation between the antennas, the system 100 can establish a set of nonlinear equations representing the distances from the source to each antenna. The solution involves finding the point where the calculated distances (based on signal strength differences) intersect, which represents the most likely location of the signal source relative to the antenna array. Furthermore, the accuracy of trilateration can be enhanced by incorporating additional antennas, which provide more distance measurements and, consequently, reduce the uncertainty in the position estimate. The use of more antennas allows for the implementation of overdetermined systems, where the additional data can be used to minimize errors and improve the robustness of the location estimation process. Trilateration is particularly advantageous in environments where the AoA measurement might be challenging due to multipath propagation or other interference effects that distort the apparent AoA. Trilateration may be used in place of or in conjunction with triangulation.

In some embodiments, the signal processing module 124 uses a MUSIC (Multiple Signal Classification) algorithm. MUSIC utilizes the eigenvalues and eigenvectors of the covariance matrix of the received signal to estimate AoA with high resolution by searching for peaks in the spatial spectrum. To address complex environments, a Multiple Signal Classification (MUSIC) algorithm can be used. In signal processing problems, the objective is to estimate from past measurements or expectations of measurements from a set of constant values upon which the received signals depend.

Further, embodiments may include a communication module 126, which establishes a secure connection with the cloud 128 to transmit data collected by the base station 102. The communication module 126 connects to the cloud 128 infrastructure to ensure the secure transfer of information. The communication module 126 then receives data from the signal processing module 124, which includes positions, velocities, and other characteristics of detected wireless devices, along with timestamps and metadata. The communication module 126 sends the data to the base module 132 in the cloud 128, where it is processed and integrated with user profiles and advertising algorithms to deliver personalized content to digital signage 144 units.

Further, embodiments may include a cloud 128, which may serve as the central processing and storage hub that integrates and manages data received from the base station 102 and the digital signage 144. The cloud 128 may perform several functions, including receiving position and movement data from the base station 102, analyzing this data to determine user behavior, and selecting appropriate advertisements for display based on this analysis. The cloud 128 includes multiple modules, each handling specific tasks to ensure seamless operation. The base module 132 may act as the primary interface, receiving data from the base station's 102 communication module 126 and determining whether the detected devices belong to groups or individuals. Based on the nature of the detected devices, whether they are part of a group or moving rapidly (e.g., a velocity faster than a predetermined threshold), the base module 132 activates different advertisement modules. These modules may include the quick ad module 134 for rapidly moving devices, the detailed ad module 136 for slower-moving individuals, the group ad module 138 for localized groups (e.g., groups localized within a particular radius), and the scattered ad module 140 for groups approaching from different areas and/or distributed across a wide area. In some embodiments, each of these modules accesses an ad database 142, filters the relevant advertisements based on device profiles, and sends the selected ads to the digital signage's 144 display module 156. The cloud's 128 infrastructure may allow it to handle data processing tasks, ensuring that the most relevant advertisements are shown to users in real-time, enhancing the effectiveness of the digital signage 144. Additionally, the cloud 128 maintains the ad database 142, continuously updating it to reflect current promotions and advertisements, which are then pushed to the digital signage 144 based on the real-time data analytics performed in the cloud 128.

Further, embodiments may include a memory 130, which may store and manage the extensive data used for the operation of the digital signage 144 networks. In some embodiments, the memory 130 may be a data storage infrastructure designed to handle various types of data, including user profiles, device information, advertisement content, and the results of data analysis processes. The memory 130 may store data received from the base station 102, such as the position, rate of change, and identification of devices detected in proximity to the digital signage 144. The memory 130 may also house detailed device profiles, which include historical data on user interactions and preferences. In some embodiments, the memory 130 may store the ad database 142, which contains a wide range of ads that can be displayed on digital signage. In some embodiments, the ad database 142 may be continually updated with new advertisements, promotional content, and marketing messages. The memory 130 may ensure that the ad modules have quick access to relevant ads, enabling real-time selection and display based on the real-time analysis of device data. In some embodiments, the memory 130 may be responsible for storing the algorithms and machine learning models used to analyze user behavior, predict future movements, and refine ad targeting strategies. In some embodiments, the memory 130 may manage logs and records of all interactions, including which ads were displayed, how users responded, and other metrics that help improve the system's performance over time. In some embodiments, the logging of data may be used for analytics and reporting to provide insights into the effectiveness of the advertisements and the behavior of users. In some embodiments, the memory's 130 architecture may be designed to support high availability and redundancy, ensuring that data is always accessible and secure, even in the event of hardware failures.

Further, embodiments may include a base module 132, which may connect to the base station 102 to receive data about nearby devices, including their profiles, location, and movement. The base module 132 determines if there are groups of devices and whether they are localized, triggering different advertisement modules based on these factors. If a localized group is detected, the group ad module 138 is activated to display relevant ads. For scattered groups, the scattered ad module 140 is used. If a single device is detected moving rapidly, the quick ad module 134 is triggered, while the detailed ad module 136 is used for stationary or slowly moving devices. This process ensures that the advertisements shown are tailored to the behavior and characteristics of the detected use.

Further, embodiments may include a quick ad module 134, which may be designed to swiftly deliver advertisements to users detected as moving quickly toward the display. The quick ad module 134 may be initiated by the base module 132 when it identifies that a device or user is approaching rapidly. The quick ad module 134 filters the ad database 142 to find suitable quick advertisements, such as time-sensitive offers or flash sales. The quick ad module 134 then compares the filtered ads against the user's device profile, which includes data like demographics, historical interactions, and inferred preferences. Using algorithms like collaborative filtering or content-based filtering, the quick ad module 134 matches the most relevant advertisement to the user. The optimal ad may be extracted from the ad database 142 and sent to the display module 156 for immediate presentation.

Further, embodiments may include a detailed ad module 136, which may be designed to select and display personalized advertisements based on user profiles and behavior. The detailed ad module 136 may filter the ad database 142 for detailed advertisements suitable for users interested in in-depth content. The detailed ad module 136 then compares the filtered ads against the user's device profile, utilizing various algorithms, such as collaborative filtering, content-based filtering, hybrid filtering, and machine learning models. The comparison process may involve scoring each ad based on relevance, with contextual and temporal factors also considered to ensure timely and appropriate ad delivery. The most relevant advertisement is extracted and sent to the display module 156 for presentation on the digital signage 144.

Further, embodiments may include a group ad module 138, which may involve filtering the ad database 142 for group-specific advertisements. The group ad module 138 analyzes the device profiles within the group, identifying shared characteristics and preferences. Based on this analysis, the group ad module 138 compares the profiles to the ad database 142 using techniques like collaborative filtering and content-based filtering. The group ad module 138 extracts and sends the most relevant advertisement to the display module 156, ensuring the ad is tailored to the interests and context of the group.

Further, embodiments may include a scattered ad module 140, which may be activated when the base module 132 identifies a group of devices spread across a wide area. The scattered ad module 140 may filter the ad database 142 for advertisements suitable for a broad and diverse audience. The scattered ad module 140 may analyze the device profiles within the group to understand common characteristics and interests, using data such as demographics, behavior, and context. The scattered ad module 140 may employ algorithms like collaborative filtering and content-based filtering to match the profiles with relevant ads. The most relevant advertisements are extracted and sent to the display module 156 for presentation.

Further, embodiments may include an ad database 142, which may be a repository that stores a vast array of advertising content and related metadata, which enables the dynamic selection and delivery of personalized ads to digital signage. The ad database 142 may contain various types of advertisements, categorized based on different criteria such as product type, target audience, time sensitivity, and more. The ad database 142 may include static image ads, video ads, interactive content, and special offers or promotions. In some embodiments, each ad entry may be accompanied by metadata, such as tags for keywords, demographic targeting information, preferred display contexts, and engagement metrics. For example, the ad database 142 may store data for a video ad promoting a new smartphone, tagged with keywords like “electronics,” “new release,” and “tech enthusiasts,” along with details on the ideal demographic, such as age and income level. Another example may be a static image ad for a limited-time sale at a retail store, tagged with “fashion,” “discount,” and “time-sensitive,” and include instructions to display it to users identified as frequent shoppers. The ad database 142 may include interactive ads for a car dealership, where users can explore features and schedule test drives, tagged with “automotive,” “family cars,” and “interactive.”

Further, embodiments may include digital signage 144, which may deliver personalized advertisements based on real-time data from users in its vicinity. In some embodiments, the digital signage 144 may include a display 146 equipped with communication interfaces 152 that connect to a base station 102. The base station 102, which utilizes phased array antennas 104, detects the positions and movement patterns of users, such as those carrying cell phones or asset tags. The information collected includes user IDs, locations, and rates of movement, which are then transmitted to the display 146 units or a connected cloud server for processing. In some embodiments, the display 146 may be connected either to internal memory or a cloud 128 based system that processes the incoming user data. The data may be integrated with an advertising module that selects and displays the most relevant advertisements based on predefined criteria and real-time inputs. In some embodiments, the system 100 may dynamically alter the content shown on the displays 146 to, tailor it to the detected user profile. For example, if a user is approaching quickly, the system 100 might display time-sensitive deals or flash sales; if the user is approaching slowly, it might present more detailed advertisements with in-depth information.

Further, embodiments may include a display 146, which may be a high-resolution, flat-panel screen designed to showcase dynamic and vibrant visual content. In some embodiments, the display 146 may be a large-format LED or LCD screen, which may vary in size depending on the installation environment, such as retail stores, airports, or public transportation hubs. The display 146 may deliver bright and clear visuals to provide readability and impact even in brightly lit areas. In some embodiments, the display 146 may include backlighting and pixel technology to provide high contrast ratios and a wide color gamut for displaying a range of vibrant and detailed advertisements. In some embodiments, the screen may be integrated into a robust and durable housing designed to withstand continuous use and exposure to varying environmental conditions, such as changes in temperature and humidity. In some embodiments, the display 146 may be used for indoor or outdoor installations. The display 146 may be equipped with a high refresh rate and fast response times to ensure smooth playback of video content and animations without lag or ghosting. In some embodiments, the display 146 may be designed to support a wide viewing angle, allowing viewers to see the content clearly from various positions around the display. In some embodiments, the display 146 may be equipped with touch-sensitive technology, allowing for interactive features that provide users a means to engage with the content directly, such as options for navigating through menus, participating in polls or quizzes, or accessing detailed product information. In some embodiments, the display 146 may be designed to be energy efficient by utilizing LED backlighting to reduce power consumption while maintaining high brightness levels.

Further, embodiments may include a processor 148, which may be a microprocessor or microcontroller unit, or MCU, that serves as the central control unit, executing software instructions to perform tasks such as data processing, content management, and display control. The processor 148 may integrate various components and systems within the digital signage 144 to provide a seamless and efficient user experience, handling basic control functions, data analytics, and interactive features. In some embodiments, the processor 148 manages the flow of data between the display 146, memory 154, communication interfaces 152, and other hardware components. In some embodiments, the processor 148 may execute the software that controls content management, display 146 rendering, and user interaction, including decoding and processing high-definition video streams, rendering graphics and animations, and handling interactive features such as touch inputs. In some embodiments, the processor 148 may work in tandem with a graphics processing unit, or GPU, to enhance the rendering of visual content, ensuring high-quality and fluid display performance. In some embodiments, the processor 148 may be responsible for running the operating system and various software applications that manage advertisements and other content. The processor 148 may handle real-time data processing tasks, such as adjusting displayed content based on user demographics or behavior, and integrates data from external sources like cloud 128 servers or local storage. In some embodiments, the processor 148 may manage communication protocols, enabling the digital signage 144 device to connect with base stations 102, sensors, and networks to receive updates and new content.

Further, embodiments may include a power source 150, which may supply electrical energy to the entire system 100, ensuring that all hardware components, including the display 146, processor 148, communication interfaces 152, and other peripherals, function properly. The power source 150 may convert electrical power from an external source into a form that the digital signage 144 device can use. In some embodiments, the power source 150 may be a power supply unit or PSU that may be integrated within the device or housed externally. In some embodiments, the PSU converts AC, or alternating current, electricity from the main power grid into DC, or direct current, electricity, which may be suitable for the internal components of the digital signage 144 system. In some embodiments, the power source 150 may be designed to provide a stable and continuous flow of electricity to maintain the device's operations, even in environments where power fluctuations might occur. In some embodiments, the power source 150 may include power management features, such as surge protection, to guard against voltage spikes and other electrical disturbances. In some embodiments, the power source 150 may include energy-efficient components and technologies, such as LED drivers for displays 146, to reduce power consumption. In some embodiments, the power source 150 may include a backup power solution, such as battery systems or, uninterruptible power supplies, or UPS, to keep the signage operational during power outages or interruptions.

Further, embodiments may include a communication interface 152, which may be a set of hardware and software components that enable the digital signage 144 to connect and communicate with external systems, networks, and devices. The communication interface 152 may serve as the gateway for data exchange, allowing the digital signage 144 to receive content updates, interact with user devices, and transmit data to and from cloud 128 servers or other networked resources. In some embodiments, the communication interface 152 may include wired connections, such as Ethernet, and wireless options, such as Wi-Fi, Bluetooth, and cellular networks. In some embodiments, the communication interface 152 may include a network adapter or modem that allows the digital signage 144 to connect to the internet or a local area network, or LAN, to download new content, software updates, and configuration settings, and provide real-time communication with cloud 128 based management platforms, which may remotely control the digital signage 144, schedule content, and monitor performance metrics. In some embodiments, communication interface 152 may support multiple protocols, such as HTTP or HTTPS for web-based data transfers, MQTT for messaging, and proprietary protocols for specific content management systems. In some embodiments, the communication interface 152 may include security features, such as encryption and authentication protocols, to protect data integrity and prevent unauthorized access.

Further, embodiments may include a memory 154, which may be the storage components used to store data and instructions that the system's processor 148 needs to function, including storing the operating system, application software, content files, such as images, videos, and advertisements, and other data used for the operation and management of the signage system. In some embodiments, the memory 154 may include volatile and non-volatile storage types. Random Access Memory, or RAM, may be a type of volatile memory used for temporarily storing data that the processor 148 needs to access quickly. In some embodiments, RAM allows the system 100 to quickly access and process data, allowing for real-time processing, such as content playback and user interaction. Non-volatile memory may be used for long-term data storage, retaining information even when the device is powered off, which may include internal storage or external storage. In some embodiments, internal storage may be a solid-state drive, SSD, or embedded flash memory and may hold the device's operating system, software applications, and content library. In some embodiments, external storage may be USB drives or SD cards, which may be used to expand the device's storage capacity. In some embodiments, the memory 154 may include cloud 128 based storage, allowing for the centralized management of content and settings, enabling updates and maintenance to be performed remotely. In some embodiments, the memory 154 may support content caching and buffering to ensure smooth playback of media, especially when streaming from remote servers.

Further, embodiments may include a display module 156, which may be responsible for presenting targeted advertisements to viewers. The display module 156 connects to the cloud 128 to receive selected ads, which are determined based on user profiles and behavior data. The display module 156 may process data independently to tailor ads in real-time. After receiving the appropriate advertisements, the display module 156 presents them on the display 146, using various formats like videos or interactive interfaces to engage the audience effectively.

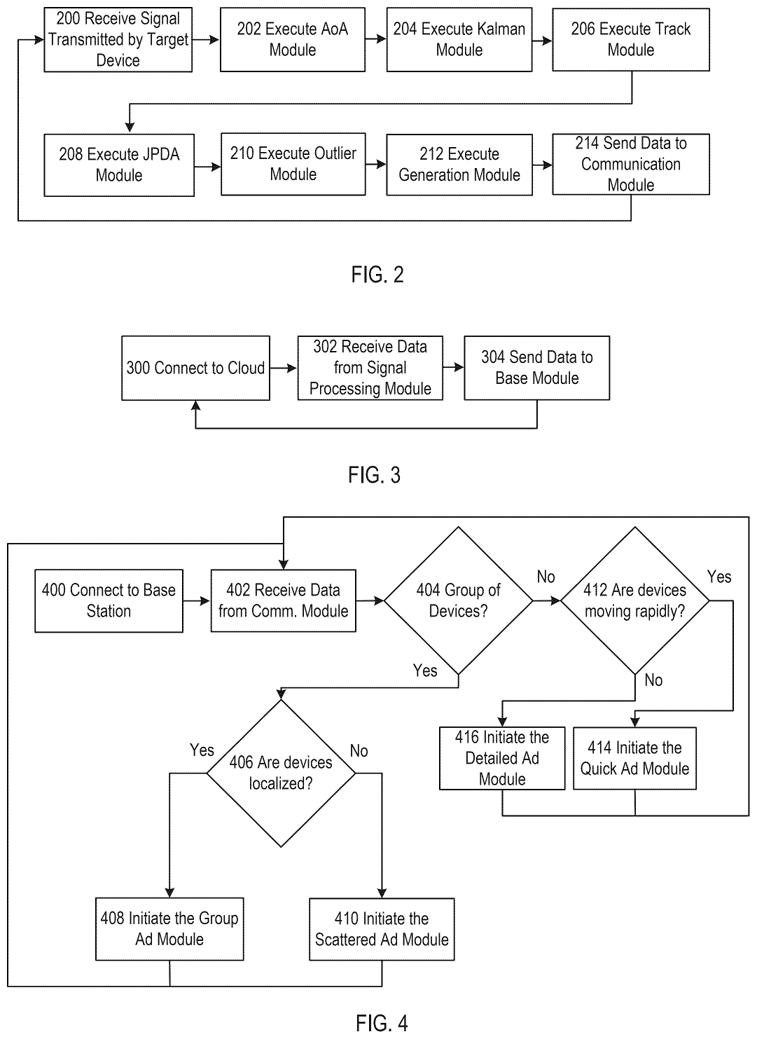

FIG. 2 illustrates the signal processing module 124. The process begins with the signal processing module 124 receiving, at step 200, the signal transmitted by the target device. The signal processing module 124 executes, at step 202, the AoA module. The AoA module determines the precise direction from which a wireless signal originates. The AoA module may capture wireless signals through the phased array antenna 104. These elements may dynamically adjust their phase and amplitude to accurately determine the direction of incoming signals. When the antenna 104 array receives a signal, each element captures the signal at slightly different times due to the spatial separation of the elements. The AoA module processes these time differences to calculate the angle of arrival of the signal. For example, the phased array antenna 104 captures incoming wireless signals from various directions. The AoA module measures the time differences between when the signal reaches each element. The AoA module calculates the phase differences of the received signal at each element. By analyzing these phase differences, the AoA module may determine the relative phase shifts caused by the different paths the signal takes to reach each element. Using the time distance of arrival and phase difference data, the AoA module may apply algorithms to calculate the precise angle from which the signal originated, which may involve solving geometric equations based on the known positions of the antenna elements and the measured time and phase differences. The elements may dynamically adjust their phase and amplitude to focus on the direction of the incoming signal. The beamforming capability enhances the accuracy of the angle of arrival determination by increasing the signal-to-noise ratio for the specific direction. The AoA module may perform real-time resistance monitoring of the elements to ensure optimal performance. The final angle of arrival data, indicating the precise direction of the incoming signal, is generated and outputted for further processing or immediate use in device tracking applications. The signal processing module 124 executes, at step 204, the Kalman module. The Kalman module may accurately predict the position of wireless devices by filtering and smoothing the incoming signal data. The Kalman module may perform estimation techniques, such as the Kalman Filter, to provide real-time tracking and prediction of device movements, ensuring high accuracy and reliability. For example, the phased array antenna 104 may capture incoming wireless signals. In some embodiments, the initial processing may involve converting these captured signals into a format suitable for further analysis. The Kalman module may initialize the state vector, which represents the device's position and velocity. This state vector is based on the initial measurements obtained from the phased array antenna 104, providing a starting point for the estimation process. The Kalman Filter within the Kalman module may predict the future state of the device using a mathematical model. The model considers the previous state and incorporates assumptions about the device's movement, such as constant velocity or acceleration. The prediction may involve calculating the predicted state vector and the associated uncertainty, for example a covariance matrix. As new signal measurements are received by the phased array antenna 104, the Kalman module updates the predicted state, which may involve comparing the predicted state with the actual measurements and computing the difference, known as the innovation or residual. The Kalman Filter then adjusts the state vector and the covariance matrix based on this innovation. The Kalman Gain is calculated to determine the optimal weight given to the new measurements versus the predicted state. The Kalman Gain ensures that the filter adapts appropriately to new information, balancing the influence of the prediction and the measurement. Using the Kalman Gain, the Kalman module may correct the state vector, refining the estimate of the device's position and velocity. This reduces the uncertainty in the state estimate, providing a more accurate and reliable prediction. The covariance matrix, representing the uncertainty of the state estimate, is updated to reflect the new measurements and the correction applied to ensure that the filter maintains an accurate assessment of the estimation uncertainty over time. The refined state vector, which represents a highly accurate estimate of the device's position and velocity, is generated as the output and may be used for real-time tracking, navigation, and other applications requiring precise location information. The signal processing module 124 executes, at step 206, the track module. The track module may match incoming signals to their respective tracked devices to ensure that the system 100 maintains accurate and continuous tracking of multiple devices in a dynamic environment. For example, the phased array antenna 104 may capture high-quality signals from multiple devices within its range. In some embodiments, the captured signals may undergo initial preprocessing to extract relevant features such as signal strength, time of arrival, and angle of arrival. For each incoming signal, the track module may generate a list of potential matches or candidates from the existing set of tracked devices, which may involve comparing the extracted signal features with the expected features of the tracked devices based on their predicted positions and characteristics. The track module calculates the likelihood that each candidate device is the source of the incoming signal. The calculation takes into account factors such as the proximity of the predicted position to the signal's point of origin and the similarity of the signal characteristics. In some embodiments, the track module may use algorithms, such as the Joint Probabilistic Data Association or JPDA, to optimize the assignment of signals to devices. The JPDA algorithm may evaluate all possible assignments and select the one that maximizes the overall likelihood to ensure that the signals are matched to their correct sources. In some embodiments, multiple devices may have similar likelihoods for a given signal. The track module may employ additional criteria to resolve ambiguities, which may include historical movement patterns, signal strength trends, and other contextual information. The track module may output the final assignments of signals to devices, providing a clear and accurate mapping of incoming signals to their respective sources. In some embodiments, the mapping may be used to update the state estimates of the tracked devices. The track module may be responsible for maintaining and updating the tracks of devices over time. The track module ensures that the tracking system can handle the initiation, maintenance, and termination of device tracks, providing continuous and accurate tracking of multiple devices. In some embodiments, the track module uses the captured signal to initiate a new track, assigning a unique identifier and recording the initial position and velocity of the device. For each tracked device, the track module updates its state based on new signal measurements received by the phased array antenna 104. It may involve incorporating the latest position, velocity, and other relevant features into the existing track. The track module may predict the future position and state of each tracked device using mathematical models, which assist in maintaining continuous tracking even when signals are temporarily lost or obstructed. The track module confirms the existence of a track by continuously receiving and associating signals from the device over a specified period. In some embodiments, tracks that do not receive consistent signal updates are flagged for potential termination. The track module terminates tracks for devices that have left the monitoring range or have not been detected for an extended period, which may involve removing the track from the active list and recording the last known state of the device. The track module may maintain the integrity of each track by handling track splits and merges. For example, if a device's signal splits into multiple tracks or if multiple tracks converge into one, the track module may resolve these situations to ensure accurate tracking. In some embodiments, the track module may store historical data for each track, including the device's movement patterns, signal characteristics, and state estimates. The signal processing module 124 executes, at step 208, the JPDA module. The JPDA module may improve the accuracy and reliability of data association in a dense signal environment. The phased array antenna 104 captures high-quality wireless signals from multiple devices. In some embodiments, the JPDA module may receive the preprocessed signals, which include various features such as angle of arrival, time of arrival, and signal strength, and use these features to generate a preliminary association of signals to their respective tracked devices. The JPDA module performs the Joint Probabilistic Data Association, or JPDA, algorithm to handle situations where multiple signals may correspond to multiple devices. JPDA calculates the probabilities of different possible associations, considering the uncertainties and variances in signal measurements. For each potential association, the JPDA module calculates a likelihood score based on the consistency of the signal characteristics with the expected values for each tracked device, which may include factors such as predicted positions and signal properties derived from the phased array antenna 104. The JPDA module may optimize the overall data association by selecting the set of associations that maximize the joint probability. In some embodiments, the clean aspect of the JPDA module may involve filtering out unlikely associations and ensuring that each signal is assigned to the most probable device without overlaps or conflicts. In some embodiments, the JPDA module identifies and removes outliers that do not fit any probable track. In some embodiments, the outliers could be due to noise, spurious signals, or devices temporarily leaving the monitoring range. In some embodiments, the high sensitivity and accuracy of the graphene phased array antenna 104 help in distinguishing true signals from outliers. The JPDA module outputs the optimized association of signals to devices. In some embodiments, the association is used to update the state estimates and positions of the tracked devices to ensure accurate and continuous tracking. The JPDA module may continuously monitor its performance, adjusting the parameters of the JPDA algorithm based on real-time feedback to ensure that the JPDA module remains adaptive and robust in varying signal environments. The signal processing module 124 executes, at step 210, the outlier module. The outlier module may handle measurements that arrive out of their expected order. The outlier module may ensure that the tracking system maintains high accuracy and reliability, even when data packets are delayed or received in an unexpected sequence. Each received signal is timestamped with the exact time of arrival, and the outlier module temporarily stores the received signals in a buffer. The outlier module sorts the signals based on their timestamps to determine the correct sequence of events. The outlier module may analyze the sequence of the buffered signals to identify any out-of-sequence measurements. It may compare the timestamps and expected order of the signals to detect discrepancies. In some embodiments, if an out-of-sequence measurement is identified, the outlier module adjusts the state estimates of the tracked devices. In some embodiments, the outlier module recalculates the positions and velocities of the devices based on the corrected sequence of signals. The outlier module may utilize a Kalman filter to update the state estimates with the out-of-sequence data. The outlier module may correct any errors introduced by the out-of-sequence measurements by recalibrating the tracking system to ensure that the device positions and velocities are consistent with the corrected data sequence. In some embodiments, the corrected and updated state estimates are integrated into the overall tracking system. The outlier module may ensure that the tracking system maintains a continuous and accurate representation of the device positions and movements. The signal processing module 124 executes, at step 212, the generation module. The generation module transform raw sensor data into a usable format for further processing and analysis. The generation module ensures that the data collected, such as the signals from the phased array antenna 104, is accurately converted and prepared for integration into the tracking system. In some embodiments, the phased array antenna 104 captures signals from multiple devices, and the generation module may receive the raw sensor data, including various parameters such as signal strength, frequency, phase information, and other relevant metrics. In some embodiments, the raw data may undergo initial preprocessing to remove any noise or irrelevant information. The preprocessed data is then converted into a standardized format that can be easily processed by the tracking system which may involve translating the raw sensor readings into digital values, ensuring compatibility with the system's data processing protocols. The generation module may standardize the units of measurement for the converted data to ensure consistency across different datasets and simplifies the integration of data. The generation module may apply calibration adjustments to the converted data based on the characteristics of the phased array antenna 104 to ensure that the data reflects accurate measurements, accounting for any variations introduced by the system's hardware. In some embodiments, each data point is timestamped to ensure accurate tracking of the temporal sequence of events. The converted and standardized data is then packaged into a format suitable for transmission and further processing which may involve organizing the data into structured packets that the tracking system can easily interpret. The generation module may prepare the packaged data for transmission to the central processing unit of the tracking system. In some embodiments, the converted, standardized, and quality-assured data may be transmitted to a central processing unit of the tracking system. The signal processing module 124 sends, at step 214, the data to the communication module 126.

FIG. 3 illustrates the communication module 126. The process begins with the communication module 126 connecting, at step 300, to the cloud 128. The communication module 126 connects to the cloud 128 infrastructure, establishing a secure channel for data transmission. In some embodiments, the secure connection may safeguard data integrity and protect against unauthorized access, employing secure communication protocols such as HTTPS or SSL. In some embodiments, the protocols may encrypt the data during transmission to ensure that sensitive information remains confidential and unaltered. The communication module 126 receives, at step 302, the data from the signal processing module 124. The data may include information such as the positions, velocities, and other characteristics of wireless devices detected by the base station 102. In some embodiments, the data set may include timestamps and metadata, which provide a detailed context for the signal measurements. For example, data might include entries like Device A's position coordinates (x=12.34, y=56.78), velocity (2.5 m/s), and a timestamp (2024-07-29 12:00:00), alongside similar metrics for other detected devices. The communication module 126 sends, at step 304, the data to the base module 132. The communication module 126 transmits the information to the base module 132 within the cloud 128. For example, device profiles might include details such as Device A's ID, known user status, user preferences, last known location, and recent activity. The data transfer may enable real-time updates and personalized content delivery to enhance the system's effectiveness and user experience.

FIG. 4 illustrates the base module 132. The process begins with the base module 132 connecting, at step 400, to the base station 102. The base module 132 establishes a connection with the base station 102 to receive real-time data collected by the base station 102, including information about the position and movement of devices in the vicinity of the digital signage system. In some embodiments, the base station 102 may process the data to determine the advertisement to be sent to the digital signage 144. In some embodiments, the base station 102 may send the determined advertisement to the digital signage 144 directly. The base module 132 receives, at step 402, the data from the communication module 126. The data may include device profiles, movement information, and other relevant metrics. In some embodiments, the data may be structured in a way that highlights specific attributes, such as device ID, location coordinates, speed, and direction. In some embodiments, the information allows for the subsequent decision-making processes in the system 100 to tailor advertisements based on the detected presence and behavior of users.

In some embodiments, the base station 102 may extract audio information from radio waves using sound demodulation technologies, allowing the system 100 to detect certain conversations, sounds, or vocal fingerprints in the vicinity of the digital signage. In some embodiments, the base station may use AI algorithms, including but not limited to large language models, or LLMs, and machine learning, or ML techniques, to perform sentiment and syntactic analysis on the captured audio data and by analyzing the tone, emotion, and context of the conversations, the AI may assess the mood and interests of individuals nearby. In some embodiments, the base module 132 may incorporate the audio data to dynamically select and display advertisements that are most likely to resonate with the detected audience. In some embodiments, the base station's 102 camera may be equipped with image recognition capabilities to detect and identify logos on clothing, accessories, or carried items, such as backpacks and computer cases. For example, if the camera detects the logo of a popular sports team on a shirt, the system 100 might display advertisements for sports gear or upcoming games. For example, if the camera recognizes logos of tech brands like Apple can prompt ads for related gadgets or services. In some embodiments, the camera may identify specific phone models, such as an Apple iPhone, which may be used to tailor ads for phone accessories, apps, or network services. In some embodiments, the system 100 may recognize physical characteristics to estimate the age of individuals walking by. For example, it may differentiate between children, teenagers, adults, and seniors based on their appearance and physical traits. It allows the system 100 to customize the advertisements to suit different age groups, ensuring that the content is relevant and appealing. In some embodiments, the camera may detect stickers on laptops, phone cases, or other personal items to provide additional context about the individual's interests and preferences. For example, a sticker of a particular music band might trigger ads for upcoming concerts or related merchandise.

The base module 132 determines, at step 404, if there is a group of devices. In some embodiments, the analysis may involve assessing the number and proximity of devices and looking for patterns that suggest group formation. For example, multiple devices moving together in a similar trajectory or located in close proximity may indicate a group. In some embodiments, the analysis may decide the type of advertisement to display and whether it should cater to individuals or groups. If it is determined that there is a group of devices, the base module 132 determines, at step 406, if the devices are localized. In some embodiments, localization may mean that the devices are not only grouped but also confined to a specific area, suggesting a common interest or purpose, such as a family or friends shopping together. In some embodiments, the base module 132 further refines the advertising strategy, potentially offering group discounts or promotions. Suppose it is determined that there is a group of localized devices the base module 132 initiates at step 408. In that case, the group ad module 138 and the process returns to receiving the data from the communications module 126. In some embodiments, the group ad module 138 may select advertisements that are relevant to groups, such as family packages, group discounts, or activities suited for multiple people. In some embodiments, the process loops back to receiving more data from the communication module 126, allowing for continuous updates and adjustments to the displayed content. If it is determined that there is a group of devices, but they are not localized, the base module 132 initiates, at step 410, the scattered ad module 140, and the process returns to receiving the data from the communications module 126. In some embodiments, the scattered ad module 140 may target ads to individuals within a group that may have diverse interests. For example, in a shopping mall, scattered advertisements might include a mix of fashion, electronics, and food offers, appealing to different preferences within a group.

In some embodiments, the process may return to receiving data from the communication module 126 to ensure the system 100 continually adapts to the changing environment and user behavior. If it is determined that there is not a group of devices, the base module 132 determines, at step 412, if the device is moving rapidly. In some embodiments, the base module 132 may assess the speed and direction of the device to gauge the urgency or nature of the user's behavior. For example, rapid movement could indicate someone is in a hurry, perhaps looking for quick information or deals that can be displayed to the individual quickly. Suppose it is determined that the device is moving rapidly; the base module 132 initiates at step 414. In that case, the quick ad module 134 and the process returns to receiving the data from the communication module 126. In some embodiments, the quick ad module 134 may prioritize advertisements that are concise and time-sensitive, such as flash sales, urgent notifications, or quick service promotions, to capture the attention of users who may not spend much time near the display. In some embodiments, the process may return to receiving data from the communication module 126 to ensure the system 100 continually adapts to the changing environment and user behavior. Suppose it is determined that the device is not moving rapidly; the base module 132 initiates at step 416. In that case, the detailed ad module 136 and the process returns to receiving the data from the communication module 126. In some embodiments, the detailed ad module 136 may focus on providing in-depth advertisements, such as product details, promotions, and interactive content. In some embodiments, the type of advertisement may be designed to engage users who have the time to interact and explore more detailed information. In some embodiments, the process may return to receiving data from the communication module 126 to ensure the system 100 continually adapts to the changing environment and user behavior.

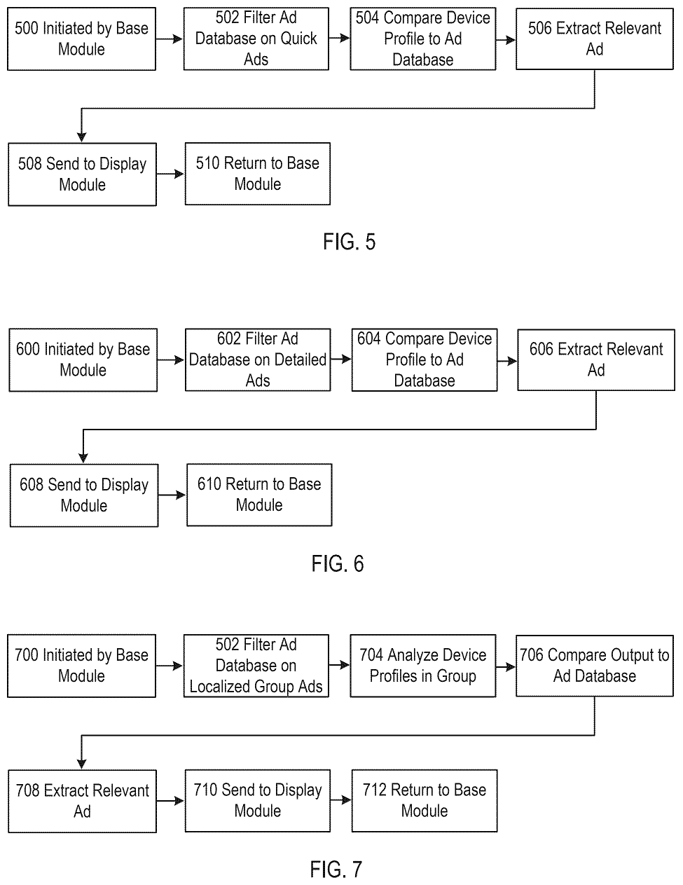

FIG. 5 illustrates the quick ad module 134. The process begins with the quick ad module 134 being initiated at step 500 by the base module 132. In some embodiments, the quick ad module 132 may be activated by the base module 132 when the system 100 detects that a device is approaching the digital signage rapidly. In some embodiments, the detection may be based on data from the base station 102, which includes movement metrics such as speed and trajectory. In some embodiments, the base module 132 may identify the urgency of reaching the approaching user quickly with relevant advertising content, thereby initiating the quick ad module 134. In some embodiments, the module may be specifically designed to handle situations where rapid user engagement is required, such as when a user is moving quickly through an area, making it crucial to present brief, impactful advertisements. The quick ad module 134 filters, at step 502, the ad database 142 on the quick advertisements. The quick ad module 134 filters the ad database 142 to isolate advertisements tagged as “quick advertisements.” In some embodiments, the ads may be pre-classified based on their suitability for rapid consumption. They typically include brief, impactful messages such as flash sales, limited time offers, or urgent announcements. In some embodiments, the filtering process may involve querying the ad database 142 for ads with specific tags or metadata indicators that denote them as quick ads. The quick ad module 134 compares, at step 504, the device profile to the ad database 142. The quick ad module 134 compares the filtered list of quick advertisements with the device profile of the approaching user. In some embodiments, the device profile may include comprehensive data such as demographic information, such as age, gender; historical interaction data, such as previous advertisements viewed or interacted with, and purchase history, if applicable. Preferences, such as favorite brands and categories, and real-time behavioral data, such as speed and direction of movement.

In some embodiments, the comparison may include content matching, which may involve direct matching of keywords and tags in the ads with those in the user's profile. For example, if the profile indicates a preference for electronic gadgets, ads related to electronics are prioritized. In some embodiments, the quick ad module 134 may utilize behavioral analysis algorithms to analyze the user's current behavior patterns, such as movement speed, to infer urgency or interest. For example, a rapidly moving user may be more interested in quick, actionable information like a flash sale rather than a detailed product description. In some embodiments, the quick ad module 134 may include contextual factors, such as the time of day, location of the signage, and current events, to enhance the relevance of the ads. For example, during a local event, ads related to the event might be prioritized. In some embodiments, the quick ad module 134 may utilize collaborative filtering, which may predict user preferences by analyzing similarities between users and ads. For example, if a particular user has shown interest in specific types of products, similar ads are highlighted. In some embodiments, the quick ad module 134 may utilize content-based filtering, which focuses on the features of the ads and the device profile to find the best match. For example, if the profile indicates a preference for eco-friendly products, the system 100 prioritizes ads tagged with “eco-friendly.” In some embodiments, the quick ad module 134 may utilize machine learning models, such as neural networks or decision trees, which may be used to predict the most relevant ads based on patterns in the data by being trained on historical data and may adapt to new trends and behaviors. In some embodiments, the quick ad module 134 may assign a relevance score to each ad based on these analyses, ranking the ads according to their scores. The highest-scoring ad deemed the most relevant to the user's current context and profile, is selected for display. The quick ad module 134 extracts, at step 506, the relevant advertisement from the ad database 142. In some embodiments, the extraction may involve retrieving the full content of the selected ad, including text, images, and any associated media files. In some embodiments, the ad may be prepared and formatted correctly for display on the digital signage 144. In some embodiments, the quick ad module 134 may check that the ad meets the technical requirements for display, such as resolution and aspect ratio, to ensure optimal presentation quality. The quick ad module 134 sends, at step 508, the extracted advertisement to the display module 156. In some embodiments, the display module 156 may be responsible for rendering the ad on the digital signage 144 display 146. The quick ad module 134 returns, at step 510, to the base module 132. In some embodiments, the quick ad module 134 may log the completion of the current ad delivery process and reset the quick ad module 134 for potential future use.

FIG. 6 illustrates the detailed ad module 136. The process begins with the detailed ad module 136 being initiated at step 600 by the base module 132. The detailed ad module 136 may be initiated by the base module 132 upon detecting a user approaching the digital signage 144 at a slower pace or showing interest in more in-depth content. The detailed ad module 136 filters, at step 602, the ad database 142 on the detailed advertisements. The detailed ad module 136 accesses the ad database 142 and filters the available advertisements based on predefined criteria that categorize them as “detailed ads.” In some embodiments, the criteria may include ads that provide comprehensive information about products or services, such as features, benefits, specifications, and detailed descriptions. The detailed ad module 136 compares, at step 604, the device profile to the ad database 142. The detailed ad module 136 may perform a comparison between the filtered advertisements and the user's device profile to ensure the most relevant ads are selected. In some embodiments, the device profile encompasses a range of data, including the user's demographics, such as age, gender, location, behavioral data, such as previous interactions with the signage, purchase history, and preferences, such as interests, favorite products, and services. In some embodiments, the detailed ad module 136 may utilize collaborative filtering, which predicts the user's interests by analyzing data from similar users. For example, suppose a user's profile indicates they have purchased a particular type of product. In that case, collaborative filtering may suggest advertisements for similar products that other users with similar profiles have shown interest in. In some embodiments, the detailed ad module 136 may utilize content-based filtering, which focuses on matching the user's profile with the content attributes of the advertisements. For example, if the user's profile shows a preference for eco-friendly products, the algorithm may prioritize ads that highlight sustainable and environmentally friendly offerings. In some embodiments, the detailed ad module 136 may utilize hybrid filtering, which combines collaborative and content-based filtering to provide a more accurate recommendation. Hybrid filtering may offer personalized advertisements by considering both the user's explicit interests and the behaviors of similar users. In some embodiments, the detailed ad module 136 may utilize machine learning models, such as decision trees, neural networks, or support vector machines, which may be employed to analyze patterns in the data and predict the likelihood of a user's engagement with different types of ads based on historical data and real-time inputs. For example, a neural network could learn to recognize which ad attributes, such as visual appeal or specific product features, are most effective for a particular user segment. In some embodiments, the detailed ad module 136 may also consider contextual factors such as the time of day, current location, and recent events or trends. For example, during a holiday season, the module might prioritize ads related to holiday sales or gift ideas. Temporal analysis ensures that the ads are not only relevant to the user's interests but also timely and contextually appropriate. In some embodiments, the comparison process may involve scoring each ad based on its relevance to the device profile, using the algorithms. In some embodiments, the ads may be ranked, and the one with the highest relevance score is selected for display. The detailed ad module 136 extracts, at step 606, the relevant advertisement from the ad database 142. The most relevant advertisement is extracted from the ad database 142 which may be based on the highest relevance score achieved to ensure the ad is highly tailored to the user's profile and current context. The detailed ad module 136 sends, at step 608, the extracted advertisement to the display module 156. In some embodiments, the display module 156 may be responsible for rendering the ad on the digital signage 144 display 146. The detailed ad module 136 returns, at step 610, to the base module 132. In some embodiments, the detailed ad module 136 may log the completion of the current ad delivery process and reset the detailed ad module 136 for potential future use.

FIG. 7 illustrates the group ad module 138. The process begins with the group ad module 138 being initiated, at step 700, by the base module 132. In some embodiments, the group ad module 138 may be initiated when the base module 132 detects a group of devices within the vicinity. For example, when multiple devices are identified as being in close proximity and moving together, indicating a group presence. The group ad module 138 filters, at step 702, the ad database 142 on the localized group ads. The group ad module filters the ad database 142 for ads that are targeted at groups, known as localized group ads. In some embodiments, the filtering process may involve searching for advertisements that are designed to appeal to group dynamics, such as family discounts, group rates, or activities suitable for multiple participants. In some embodiments, the filtering criteria may be based on the ad metadata, which categorizes ads according to their target audience. The group ad module 138 analyzes, at step 704, the device profiles in the group. For example, the data may be aggregated from each device in the group, which includes information like demographic details, such as age, gender, etc., browsing history, previous interactions with the digital signage, and current context, such as time of day and location. For example, if the devices belong to family members shopping together, the data may indicate interests in children's products or family dining. The relevant features may be extracted from the aggregated data, including common interests, purchase histories, or frequently visited locations to assist in determining the group's shared characteristics. For example, if the majority of the group members have shown interest in sports, this would be a key feature. In some embodiments, clustering algorithms, such as K-means or hierarchical clustering, may be used to identify sub-groups within the overall group allowing the group ad module 138 to find commonalities or distinct clusters. For example, within a large family group, there might be clusters of interests such as electronics for teenagers and home appliances for adults. In some embodiments, the context of the group's visit, such as shopping mall, airport, event venue, may be considered to refine the analysis. For example, if the group is at an airport, the focus might shift towards travel-related services and products. In some embodiments, the group ad module 138 may analyze behavioral patterns such as browsing speed, time spent viewing specific ads, and interaction with the signage. The group ad module 138 compares, at step 706, the output of the analysis to the ad database 142.

In some embodiments, the ad database 142 may contain a wide range of advertisements, each tagged with metadata indicating target demographics, interests, and contexts. The group ad module 138 may query the database for ads that match the identified aggregated profile features and context. The group ad module 138 may assign relevance scores to potential ads using algorithms such as collaborative filtering, content-based filtering, or hybrid systems. In some embodiments, the algorithms compare the group's features with the attributes of the advertisements. In some embodiments, collaborative filtering may use historical data on what similar groups have responded well to. For example, if groups similar to the current one have shown interest in electronics discounts, the system 100 prioritizes electronic ads. In some embodiments, content-based filtering may focus on the specific content preferences indicated by the group's profile. For example, if the group's profile highlights an interest in outdoor activities, ads related to sports equipment or adventure trips are scored higher. In some embodiments, hybrid filtering may combine collaborative and content-based filtering to improve accuracy and relevance. In some embodiments, machine learning models, such as decision trees or neural networks, may be employed to optimize the selection process. The models may consider various factors, including user engagement history, ad effectiveness metrics, and current market trends. In some embodiments, the models may be trained on historical data to predict which ads are likely to perform best. In some embodiments, the group ad module 138 may involve scoring each ad based on its relevance to the device profiles, using the algorithms. In some embodiments, the ads may be ranked, and the one with the highest relevance score is selected for display. The group ad module 138 extracts, at step 708, the relevant advertisement. In some embodiments, the ad may be chosen because it best matches the group's profile and is likely to attract their attention. In some embodiments, the extraction process ensures that the selected advertisement is ready for immediate display, optimizing the engagement potential. The group ad module 138 sends, at step 710, the extracted advertisement to the display module 156. The extracted advertisement is then sent to the display module 156, which is responsible for presenting the advertisement on the digital signage screens. The group ad module 138 returns, at step 712, to the base module 132.

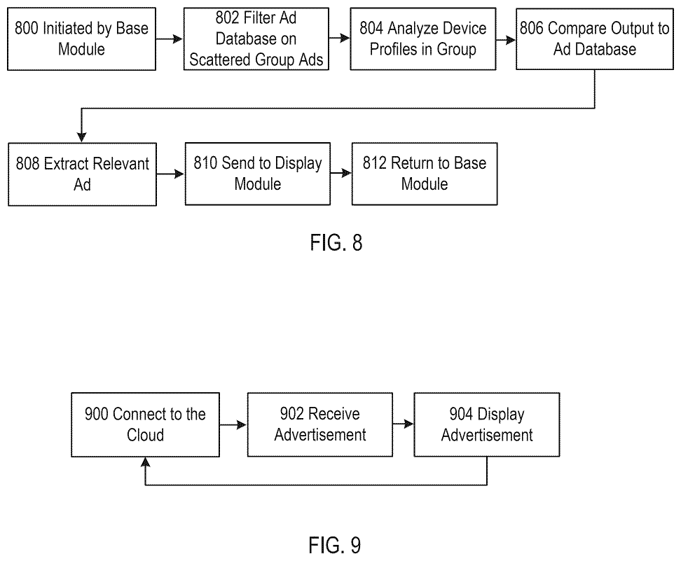

FIG. 8 illustrates the scattered ad module 140. The process begins with the scattered ad module 140 being initiated at step 800 by the base module 132. The scattered ad module 140 may be initiated when the base module 132 detects that a group of devices, though identified as a group, is spread across a wide area rather than being clustered together in a specific location. In some embodiments, the scattered ad module 140 may be to display advertisements that appeal to a broadly distributed audience with potentially diverse interests. The scattered ad module 140 filters, at step 802, the ad database 142 on the scattered group ads. The scattered ad module 140 filters the ad database 142 for advertisements designed for scattered groups.

In some embodiments, the filtering process may involve selecting ads that are broad in appeal and may engage a diverse audience. In some embodiments, the scattered ad module 140 may identify ads that are tagged with metadata indicating they are suitable for a varied demographic or those that are likely to appeal to general interests. For example, ads promoting popular entertainment events, widely appealing consumer electronics, or universal service offerings such as food delivery services might be selected during this step. The scattered ad module 140 analyzes, at step 804, the device profiles in the group. The scattered ad module 140 may aggregate data from each device in the group, including information like demographic details, such as age, gender, etc., browsing history, previous interactions with the digital signage, and current context, such as time of day and location. For example, if the devices belong to individuals scattered throughout a shopping mall, the data may indicate a variety of interests, such as clothing stores, electronics, or food courts. In some embodiments, the relevant features may be extracted from the aggregated data. The features may include common interests, purchase histories, or frequently visited locations to assist in determining the diverse characteristics of the group. For example, some individuals might have shown interest in luxury brands, while others are interested in budget-friendly options.

In some embodiments, the scattered ad module 140 may use clustering algorithms, such as K-means or hierarchical clustering, to identify sub-groups within the scattered group. In some embodiments, this allows the scattered ad module 140 to find commonalities or distinct clusters when a group consist of member with diverse interests. For example, within a diverse group in a shopping area, there might be clusters of interests such as gourmet food for food enthusiasts and gaming gadgets for tech-savvy individuals. In some embodiments, the context of the group's location, such as various stores or food courts within a shopping center) may be considered to refine the analysis. For example, if some individuals are near fashion outlets, the focus might shift toward clothing and accessory promotions. In some embodiments, the scattered ad module 140 may analyze behavioral patterns such as browsing speed, time spent viewing specific ads, and interaction with the signage and to predict the group's engagement level and potential ad responsiveness. The scattered ad module 140 compares, at step 806, the output of the analysis to the ad database 142. The scattered ad module 140 proceeds to match the profiles with the advertisements stored in the ad database 142. In some embodiments, the ad database 142 may contain a wide range of advertisements, each tagged with metadata indicating target demographics, interests, and contexts. The scattered ad module 140 may query the ad database 142 for ads that match the identified aggregated profile features and context. In some embodiments, the scattered ad module may assign relevance scores to potential ads using algorithms such as collaborative filtering, content-based filtering, or hybrid systems. In some embodiments, the algorithms may compare the group's features with the attributes of the advertisements. In some embodiments, collaborative filtering may use historical data on what similar groups have responded well to. For example, if groups similar to the current one have shown interest in tech gadgets, the system 100 prioritizes tech gadget ads. In some embodiments, content-based filtering may focus on the specific content preferences indicated by the group's profile. For example, if the group's profile highlights an interest in health and wellness, ads related to fitness equipment or health food stores are scored higher. In some embodiments, hybrid filtering may combine collaborative and content-based filtering to improve accuracy and relevance. In some embodiments, machine learning models, such as decision trees or neural networks, may be employed to optimize the selection process. The models may consider various factors, including user engagement history, ad effectiveness metrics, and current market trends. In some embodiments, the machine learning models may be trained on historical data to predict which ads are likely to perform best.

The scattered ad module 140 selects the ads with the highest relevance scores. In some embodiments, the selection process may ensure that the ads chosen are not only relevant but also have a high potential to engage the group based on past data and predictive modeling. The scattered ad module 140 extracts, at step 808, the relevant advertisement. The selection may include choosing ads with the highest relevance scores and those likely to engage the audience effectively. In some embodiments, the ads may be tailored to appeal broadly, covering a range of interests present in the scattered group. For example, the module might select an ad campaign promoting a new movie release that appeals to a wide demographic, ensuring it resonates with as many individuals as possible within the group. The scattered ad module 140 sends, at step 810, the extracted advertisement to the display module 156. In some embodiments, the scattered ad module 140 may format the ads for display to ensure that they are visually appealing and contextually appropriate for the digital signage's location and the time of day. The scattered ad module 140 returns, at step 812, to the base module 132.

FIG. 9 illustrates the display module 156. The process begins with the display module 156 connecting, at step 900, to the cloud 128. In some embodiments, the connection may allow the display module 156 to receive advertisements and other relevant data processed by the cloud's 128 various modules, including the quick ad module 134, detailed ad module 136, group ad module 138, and scattered ad module 140. In some embodiments, the processing tasks performed by the cloud 128, such as filtering, analysis, and selection of advertisements, may also be performed by the display module 156. The display module 156 receives, at step 902, the advertisement from the cloud 128. In some embodiments, the advertisement may have been selected based on the analysis of device profiles, user behavior, and other contextual factors. For example, the display module 156 may receive a dynamic, attention-grabbing advertisement if the system 100 detects a rapidly moving audience, which may be sent by the quick ad module 134. For a slowly approaching individual, a more detailed and informative advertisement may be sent by the detailed ad module 136, offering product descriptions or in-depth service information. In some embodiments, the advertisements for localized groups may promote group offers or events suitable for multiple people, while scattered groups might see a broader range of ads catering to diverse interests. The display module 156 displays, at step 904, the advertisement, and the process returns to receiving the advertisement from the cloud 128. The display module 156 presents the received advertisement on the physical display 146, which may involve rendering the content in a visually engaging manner, appropriate to the ad's design and the context in which it is shown. For example, the display 146 may showcase a vibrant, animated video for a flash sale aimed at quickly capturing attention, or it may display an interactive touchscreen interface allowing users to explore product features or services in detail. For group-related content, display 146 may highlight nearby group activities or dining options suitable for the detected audience.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A system for dynamic digital signage based on device movement, the system comprising:
memory that stores one or more content files;
a digital signage device that displays one or more of the content files;
an antenna array that receives signals from one or more wireless devices within an associated range;
a signal processor that determines a real-time location and a movement velocity of each of the one or more wireless devices based on the signals received by the antenna array; and
at least one processor that executes instructions stored in memory, wherein the at least one processor executes the instructions to:
determine that each of the one or more wireless devices is part of a same group when the respective real-time location of each wireless device is localized within a particular radius and indicates movement along a common trajectory;
determine that the movement velocity of the respective wireless device is faster than a threshold velocity relative to the digital signage device; and
select a content file from among the stored content files to be displayed on the digital signage device based on the determination that the wireless devices are part of the same group and that the movement velocity is faster than the threshold velocity.

2. The system of claim 1, wherein the memory further stores device profiles that include information regarding one or more of characteristics and preferences of a user associated with one or more of the wireless devices, and wherein the at least one processor further filters the content files based on the information regarding the characteristics and preferences in the device profiles.

3. The system of claim 2, wherein the device profiles further include demographic information of a user associated with one or more of the wireless devices, and wherein the at least one processor further filters the content files based on the demographic information in the device profiles.

4. The system of claim 1, wherein the at least one processor prioritizes selection of the content file based on being suitable for rapid consumption when the movement velocity is determined to be faster than the threshold velocity.

5. The system of claim 4, wherein the selected content file is pre-classified as suitable for rapid consumption.

6. The system of claim 1, wherein the wireless devices includes one or more of a cell phone and an asset tag.

7. The system of claim 6, wherein the asset tag includes one or more of a radio frequency identification (RFID) tag, a near field communication (NFC) tag, a Wi-Fi tag, a global position system (GPS) tag, and a long range (LoRa) tag.

8. The system of claim 1, wherein the signal processor determines the real-time location of each of the one or more wireless devices using at least one of an Angle of Arrival (AoA) measurement, a Kalman filter, a Joint Probabilistic Data Association (JPDA) operation, and a Multiple Signal Classification (MUSIC) algorithm.

9. The system of claim 1, wherein the signal processor determines the real-time location of each of the one or more wireless devices based on triangulation or trilateration.

10. The system of claim 1, wherein the antenna array pings the wireless devices for the signals when in active mode, and wherein the the antenna array does not ping the wireless devices when in a passive mode.

11. A method for dynamic digital signage based on device movement, the method comprising:
storing one or more content files in memory;
receiving signals from one or more wireless devices within a range associated with an antenna array;
determining a real-time location and a movement velocity of each of the one or more wireless devices; and
executing instructions stored in memory, wherein execution of the instructions by a processor:
determines that each of the one or more wireless devices is part of a same group when the respective real-time location of each wireless device is localized within a particular radius and indicates movement along a common trajectory;
determines that the movement velocity of the respective wireless device is faster than a threshold velocity relative to the digital signage device; and
selects a content file from among the stored content files to be displayed on the digital signage device based on the determination that the wireless devices are part of the same group and that the movement velocity is faster than the threshold velocity.

12. The method of claim 11, further comprising storing device profiles that include information regarding one or more of characteristics and preferences of a user associated with one or more of the wireless devices, and further comprising filtering the content files based on the information regarding the characteristics and preferences in the device profiles.

13. The method of claim 12, wherein the devices device profiles further include demographic information of a user associated with one or more of the wireless devices, and further comprising filtering the the content files based on the demographic information in the device profiles.

14. The method of claim 11, wherein selecting the content file includes prioritizing suitability for rapid consumption when the movement velocity is determined to be faster than the threshold velocity.

15. The method of claim 14, wherein the selected content file is pre-classified as suitable for rapid consumption.

16. The method of claim 11, wherein the wireless devices includes one or more of a cell phone and an asset tag.

17. The method of claim 16, wherein the asset tag includes one or more of a radio frequency identification (RFID) tag, a near field communication (NFC) tag, a Wi-Fi tag, a global position system (GPS) tag, and a long range (LoRa) tag.

18. The method of claim 11, wherein determining the real-time location of each of the one or more wireless devices includes using at least one of an Angle of Arrival (AoA) measurement, a Kalman filter, a Joint Probabilistic Data Association (JPDA) operation, and a Multiple Signal Classification (MUSIC) algorithm.

19. The method of claim 11, wherein determining the real-time location of each of the one or more wireless devices is based on triangulation or trilateration.

20. The method of claim 11, further comprising pinging the one or more wireless devices via the antenna array when in active mode and not pinging the one or more wireless devices when in passive mode.

21. A non-transitory, computer-readable storage medium, having embodied thereon a program executable by a processor to perform a method for dynamic digital signage based on device movement, the method comprising:
storing one or more content files in memory;
receiving signals from one or more wireless devices within a range associated with an antenna array;
determining a real-time location and movement velocity of each of the one or more wireless devices;
determining that each of the one or more wireless devices is part of a same group when the respective real-time location of each wireless device is localized within a particular radius and indicates movement along a common trajectory;
determining that the movement velocity of the respective wireless device is faster than a threshold velocity relative to the digital signage device; and
selecting a content file from among the stored content files to be displayed on the digital signage device based on the determination that the wireless devices are part of the same group and that the movement velocity is faster than the threshold velocity.
